(19) United States
(12) Patent Application Publication
(10) Pub. No.: US 2022/0370952 A1
(43) Pub. Date: Nov. 24, 2022

(54) METHOD AND SYSTEM FOR FILTERING FORMALDEHYDE FROM INOOR AIR

(71) Applicant: enVerid Systems, Inc., Westwood, MA (US)

(72) Inventors: Udi MEIRAV, Newton, MA (US); Israel BIRAN, Avihayil (IL); Karthik RAMASWAMI, McKinney, TX (US); Shira ROSENCWAIG, Modin (IL)

(21) Appl. No.: 17/862,345

(22) Filed: Jul. 11, 2022

Related U.S. Application Data
(63) Continuation of application No. 16/246,247, filed on Jan. 11, 2019.
Application No. 16/246,247 is a continuation of application No. 15/022,554, filed on Mar. 16, 2016, now abandoned.
(60) Provisional application No. 61/878,055, filed on Sep. 16, 2013.

(51) Int. Cl. B01D 53/14; B01D 53/72; B01D 53/80; B01D 39/02

(52) U.S. Cl. CPC B01D 53/1487; B01D 53/72; B01D 53/80; B01D 39/02; B01D 53/1493; B01D 2253/102; B01D 2257/708; B01D 2253/104; B01D 2253/106; B01D 2252/20484; B01D 2252/20489; B01D 2259/4508; B01D 2239/0407; B01D 2252/2041; B01D 2252/20415; B01D 2253/25; B01D 2252/204; B01D 2253/11; B01D 2253/302; B01D 2252/20405

(57) ABSTRACT

Embodiments of the present disclosure are directed to systems and methods for removing formaldehyde from indoor air. Some embodiments include flowing an indoor airflow over and/or through a solid supported amine filtering medium, such that, at least a portion of formaldehyde entrained in the indoor airflow is removed therefrom. Some other embodiments include systems having one or more fans for providing velocity to one and/or another airflows (e.g., airflows to/from a formaldehyde filter).

### CROSS-REFERENCE TO RELATED APPLICATIONS

This application claims priority to U.S. Provisional Patent Application No. 61/878,055 filed Sep. 16, 2013, and entitled “Method and System for Removing Formaldehyde from Indoor Air”, the entire disclosure of which is incorporated herein by reference in its entirety.

### TECHNICAL FIELD

Embodiments of the present disclosure generally relate to systems, methods and devices for air treatment and more particularly to cleaning indoor air in buildings, homes, vehicles and other closed spaces.

### BACKGROUND

Indoor air quality is affected by a plurality of contaminants, many of which belong to the category of volatile organic compounds (VOCs). Formaldehyde, one of the most common VOCs is regulated by the Occupational Safety and Health Administration (OSHA) and is considered to be a carcinogen. It is commonly emitted from many building materials such as plywood, particleboard and glues, as well as some fabrics and foam insulations, which are implicated in the release of formaldehyde into the indoor air. Formaldehyde is also a secondary pollutant produced, for example, by reactions of ions or ozone in ambient air with various other pollutants, and thus sometimes is an unwanted byproduct of systems intended to improve air quality.

Many buildings manage indoor air quality in part by directly removing pollutants from indoor air by means of sorbents, catalysts or ionizers. However, formaldehyde is adsorbed poorly by common sorbent materials such as activated carbon, and is not always responsive to other VOC removal technologies. Indeed, formaldehyde contamination can even be exacerbated by reactive processes mentioned above, thus requiring a different mitigation approach.

Amines may bind to aldehydes through chemical reactions, such as the Mannich reaction. However, most amines are in liquid form at room temperature, which makes them relatively difficult to be used as air filters, as in the case of cleaning a stream of indoor air.

### SUMMARY OF SOME OF THE EMBODIMENTS

Some embodiments of the disclosure provide systems, methods and devices for filtering formaldehyde from indoor air.

According to some embodiments, there is provided a solid-supported amine filter medium which may be made by combining liquid amine with a granular solid support material, such as silica, clay or other suitable materials, whereby the amine molecules attach to the surfaces of the solid support material.

In some embodiments, a material composition and a method and system for removing and/or filtering formaldehyde from indoor air. In some embodiments, the system uses formaldehyde-selective solid-supported amine filter medium, configured to come into contact with circulating indoor air and thereby filter (i.e., remove) formaldehyde and other aldehydes molecules from the airflow.

According to some embodiments, there is provided a method for removing formaldehyde from indoor air comprising flowing an indoor airflow over and/or through a solid supported amine filtering medium, such that, at least a portion of formaldehyde entrained in the indoor airflow is removed therefrom.

In some embodiments, the amine may be selected from the group consisting of: 2,4-dinitrophenylhydrazine, mono ethanolamine, polyethylenimine, tetraethylenepentamine, pentaethyleneheptamine, and diethanolamine.

In some embodiments, the filtering medium comprises granular particles ranging in size from about 0.1 mm diameter to about 3 mm diameter. The granular particles of the filtering medium may be arranged in one or more filter sheets so as to allow interaction between the formaldehyde in the indoor air flowing through the medium and amines in the medium.

In some embodiments, one or more fans are included which provides a velocity to one and/or another of the airflows in disclosed systems. For example, such fans provide a face velocity of the airflow impinging the filtering medium may be between about 10 cm/s to about 500 cm/s. In some embodiments, the face velocity of the airflow impinging the filtering medium may be between about 0.5 cm/s to about 10 cm/s. In some embodiments, the face velocity of the airflow impinging the filtering medium may be between about 0.1 cm/s to about 0.5 cm/s.

In some embodiments, the filtering medium is provided in a form selected from the group consisting of: sheets, films, monoliths, linings of interiors of air ducts, and wall linings.

In some embodiments, airflow over and/or through the filtering medium may be facilitated by at least one of a fan, a blower, a valve, a shutter and a damper. The airflow over and/or through the filtering medium may be configured in a parallel slip stream to a main air circulation path.

According to some embodiments, there is provided a system for removing formaldehyde from indoor air including an indoor air inlet for at least one of flowing and directing an indoor airflow to and/or from an enclosed space and a formaldehyde filter configured to receive the indoor airflow prior to the indoor airflow being returned to the enclosed space. The filter may include a solid supported amine filtering medium configured to intercept formaldehyde upon the indoor airflow flowing over and/or through the filtering medium.

In some embodiments, the filtering medium may include a material formed from the combination of liquid amine with one or more granular solid support materials selected from the group consisting of: silica, clay, alumina, carbon polymer, fiber, or combinations thereof.

In some embodiments, the system may further include a controller and air quality sensors. In such embodiments, the controller may activate the system for removing formaldehyde from indoor air based on air quality measurements, measured by (for example) the air quality sensors. The system may further include one or more filter sheets configured with granular particles of the filtering medium so as to allow interaction between the formaldehyde in the indoor air flowing over and/or through the filtering medium. One or more filter sheets comprise a plurality of filter sheets arranged in at least one of a v-bank formation and a parallel stacking configuration. The filtering medium is in a form selected from the group consisting of: sheets, films, monoliths, linings of interiors of air ducts, and wall linings.

In some embodiments, the filter sheet comprises a thickness between about 1 cm to about 20 cm. In some embodiments, the filter sheet may include a thickness less than about 1 cm. The filter sheet may be formed as a flat rectangular sheet with permeable screens for enclosing the filtering medium. In some embodiments, the filter sheet may be formed in a non-planar shape.

Details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The principles and operations of the systems, apparatuses and methods according to some embodiments of the present disclosure may be better understood with reference to the drawings, and the following description. The drawings are given for illustrative purposes only and are not meant to be limiting.

FIG. 1 is a graph showing formaldehyde filtering efficiency of an exemplary indoor air formaldehyde filtering system, according to some embodiments of the present disclosure; and

FIGS. 2A-2D are schematic illustrations of an exemplary indoor air formaldehyde filtering system, according to some embodiments of the present disclosure.

### DETAILED DESCRIPTION OF SOME OF THE EMBODIMENTS

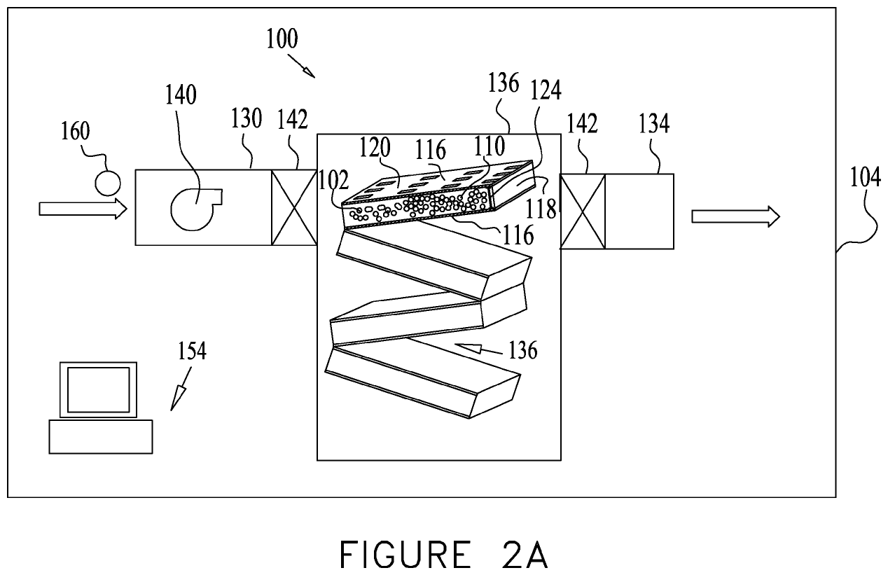

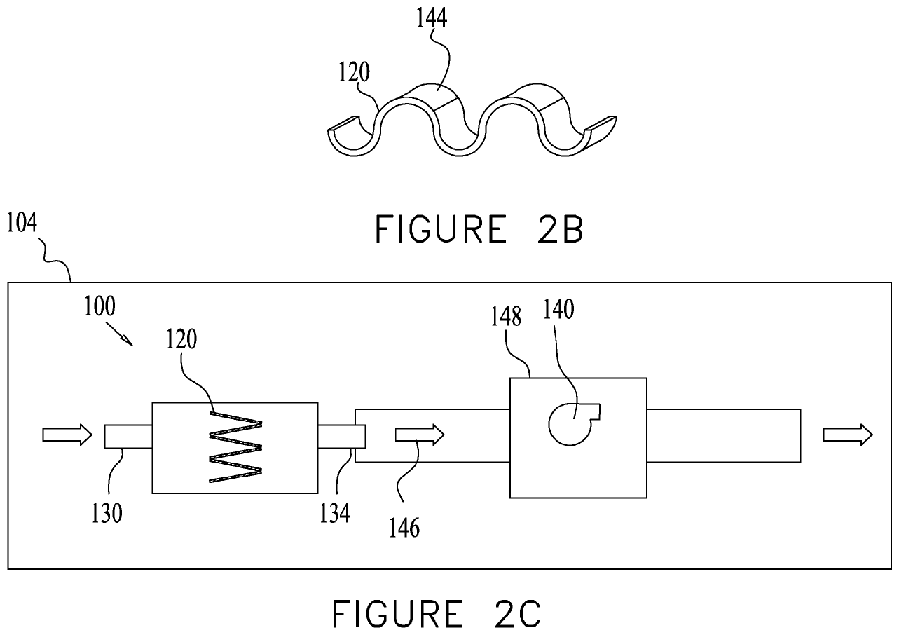

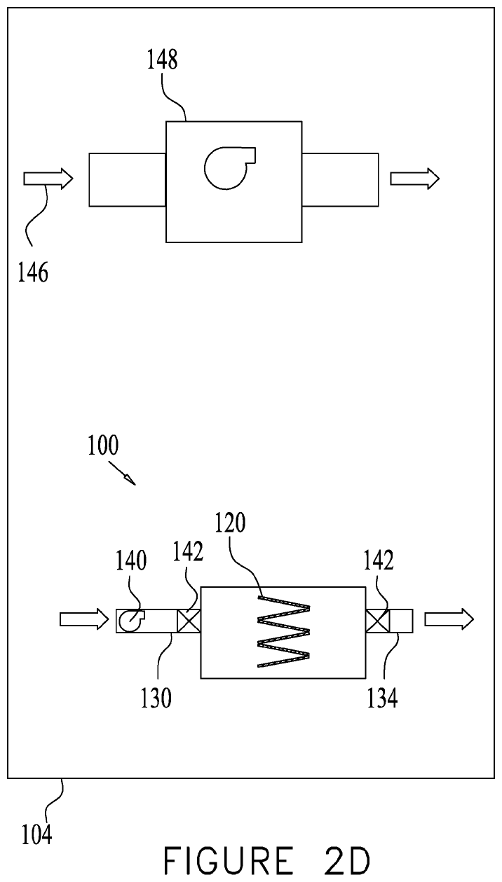

In accordance with some embodiments of the disclosure, there is provided a system 100 (FIG. 2A) including a medium for filtering, for example, trace formaldehyde (CH₂O) from indoor air. In some embodiments, the formaldehyde filtering system 100 may include a solid supported amine.

In some embodiments, the filter medium may be formed by impregnation of bentonite, a natural forming clay mineral, with diethanolamine (DEA), followed by pelletization with water or any other suitable binder liquid. The impregnation process may be similar to that which was described in U.S. Pat. No. 6,908,497 by R. Siriwardane, as a method to create a sorbent for carbon dioxide for treatment of power plant emissions. U.S. Pat. No. 6,908,497 is incorporated herein by reference in its entirety. Other amines and other solids are known Amines may include monoethanolamine, diethanolamine, polyethylenimine, tetraethylenepentamine, pentaethylene-heptamine, to name a few, which are relatively viscous liquids at ambient temperatures.

In some embodiments, other materials may be used. For example, other high surface area materials including other clays, various forms of silica, alumina, zeolite, carbon, polymer, fiber, or combinations thereof and other materials are alternative candidates for the solid support.

The support may be formed in any suitable form. In some embodiments, the combined amine and support may comprise granular particles, whose size, according to some preferred embodiments, varies between about 0.1 mm in diameter to about 3 mm in diameter, other particle sizes are also possible and practical.

In some embodiments, larger particles may be easier to handle but present reduced filtration capability due to less surface area, and smaller particles may have good filtration but higher flow impedance and pressure drop.

In some embodiments, the granular filter medium may be placed in a packed bed with a predetermined thickness and cross sectional geometry, held in place by (for example) two parallel, permeable screens and a rigid frame, that together supports the granules while allowing air to flow through the material. Such a packed bed may be referred to as a formaldehyde filter which may be formed as a filter sheet (120 in FIG. 2A) or any other suitable configuration. Single or multiple filter sheets 120 may be constructed and filled with the granular medium, as shown in FIG. 2A.

Thus, in some embodiments, there is provided a formaldehyde filtering system 100 for removing formaldehyde from indoor air by flowing an indoor airflow over and/or through the solid supported amine medium, such that, at least a portion of formaldehyde entrained in the indoor airflow is adsorbed or otherwise removed (i.e., filtered) therefrom.

The example as set forth herein is meant to exemplify some of the various aspects of carrying out some embodiments of the present disclosure and is not intended to limit any of the embodiments of the disclosure in any way.

Example procedure. A square filter sheet of 60 by 60 cm and a thickness of 2.5 cm was filled with approximately 7.5 kg of bentonite-diethanolamine composite formed by spraying heated diethanolamine on granulated calcined bentonite (BASF AG-160) in an Eirich mixer under ambient temperature, until reaching about 30% weight ratio of amine to bentonite. The filter sheet was placed in an air handling cabinet such that air was forced to flow through the filter, assisted by a fan. The filter sheet was exposed to an airflow, controlled by a variable speed fan, at over a range from about 7 cm/s to about 42 cm/s at 25° C. through the entire 60×60 cm cross section of the filter sheet, corresponding to a total volumetric airflow of 50 to 300 cubic feet per minute (CFM).

The incoming air was contaminated with formaldehyde in a partially controlled manner. The introduction of formaldehyde to the incoming air was performed by positioning a half filled small vial of 2.5 cm in diameter and 1 cm in height with formaldehyde solution (37% in water, Sigma, F1635) in the opening of the inlet air duct (20 cm in diameter), thus, air flowing over the vial became enriched with formaldehyde vapor. The formaldehyde concentrations in the air stream were measured both before and after the filter sheets, simultaneously, according to the NIOSH 2016 procedure for determining formaldehyde levels in air. Sampling was conducted using Formaldehyde specific sampling tubes from Prism Analytical Technologies (A14 Formaldehyde sorbent tube) connected to a 200 milliliters/minute air pump. Two such pumps and tubes were placed in close proximity to the filter sheet, one before and the other after the filter sheet, and so air was sampled for formaldehyde before and after it passed through the filter sheet. Sampling duration was 20-30 minutes, after which sampling tubes were sealed. Analysis of the tube content was conducted by high-performance liquid chromatography (HPLC) after extraction with acetonitrile, according to the NIOSH 2016 method.

The tests were performed at three different flow rates measured by volumetric flow and from which was calculate the face velocity as shown in Table 1:

TABLE 1

| | Volumetric Flow | Face Velocity |
|---|---|---|
| Case | (cubic feet per minute) | (cm/s) |
| I | 50 | 7 |
| II | 85 | 12 |
| III | 300 | 42 |

The face velocity is calculated from the total volumetric flow rate divided by the aggregate surface of the filter sheets.

Thus, the formaldehyde filtration efficiency at these different flow rates can be assessed by subtracting from 100% the ratio of outgoing to incoming formaldehyde. Due to the method of introducing the formaldehyde vapor to the air stream, the concentration of incoming formaldehyde may vary from case to case. The results are shown in Table 2.

TABLE 2

| | Incoming | Outgoing | |
|---|---|---|---|
| Case | Formaldehyde | Formaldehyde | Efficiency |
| I | 900 ppb | 200 ppb | 78% |
| | (part per billion) | | |
| II | 1100 ppb | 250 ppb | 77% |
| III | 300 ppb | 175 ppb | 42% |

The amine filter sheet has a high rate of interception of formaldehyde at all measured flow rates, though as expected the efficiency is somewhat lower at the very high flow rate of Case III. At Case II, for example, the analysis results showed an incoming formaldehyde concentration of 1100 ppb and an outgoing formaldehyde concentration of 250 ppb, corresponding to an efficiency of about 77% and the net removal of approximately 60 micrograms of formaldehyde per second. By stacking multiple filter sheets and increasing the overall volumetric flow rate, such systems comprising filter sheets can be utilized to reduce larger amount of formaldehyde from an air stream.

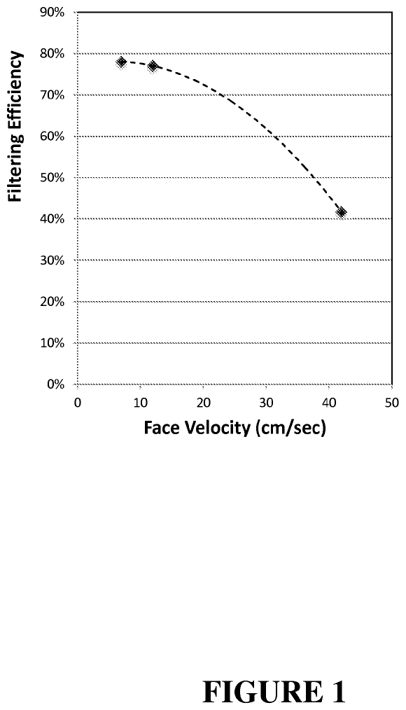

FIG. 1 shows the filtering efficiency plotted against face velocity, with a polynomial interpolation curve.

The efficiency may depend on a number of factors including the incoming formaldehyde concentration, the material properties of the solid-amine filter medium, the thickness of the bed and the airflow velocity. In some embodiments, higher flow rates may be selected. For example, comparing Case I and Case III, the efficiency in Case III is only 42%, compared with 78% in Case I. However the volumetric flow rate is 6 times higher, so the total amount of formaldehyde mass captured per any given time interval is more than three times larger in Case III. In some cases the lower flow rate may be selected, for example to achieve very low formaldehyde concentrations or to maintain lower pressure drops along the filter sheet. In some cases, higher flow rate with larger formaldehyde mass capture may be selected to maximize contaminant mass removal.

In some embodiments, the formaldehyde filtering efficiency can vary between about 25%-100%. In some embodiments, the formaldehyde filtering efficiency can be between about 10%-99%. In some embodiments, the formaldehyde filtering efficiency can be between about 5%-80%.

Similarly, the face velocity of the air stream can be designed by selecting the total volumetric flow rate and the aggregate surface of the filter sheets 120. In some embodiments, the face velocity can be between about 10-500 cm/s. In some embodiments, the face velocity can be between about 0.5-10 cm/s. In some embodiments, the face velocity can be between about 0.1-0.5 cm/s. In some embodiments, the face velocity can be under about 0.1 cm/s.

The Mannich reaction between amines and formaldehyde forms secondary alcohols. A wide variety of primary and secondary amines interact with aldehydes and in particular with formaldehyde. The Mannich interaction may be described by the following scheme:

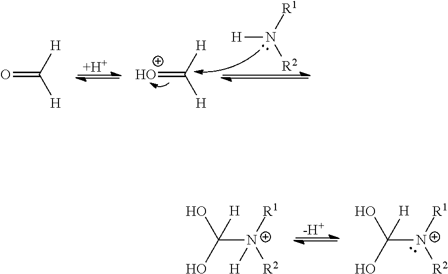

The substantial reduction in formaldehyde in the air stream may be attributed to a chemical interaction between the formaldehyde and the free amine groups in the solid material as the air flows through the dense granular medium, thereby enabling the use of such filter sheets 120 to remove unwanted formaldehyde from an air stream. The specifics of the underlying interactions can be more complex than the simple Mannich reaction described above, especially in the presence of other gas species that can interfere in the process like carbon dioxide, as well as multiple amine species, including primary and secondary amines, leading to multiple molecular pathways and reactants.

It is noteworthy that the reaction may not be reversible in some instances. This is markedly different from other applications of solid supported amines, in particular amines used to capture carbon dioxide by forming carbonate, whereby the carbon dioxide is readily released in a temperature-swing adsorption cycle by heating the amines. In the case of formaldehyde, such reverse reaction may not be practical, nor is it necessary for achieving a commercially reasonable filter lifetime, as the following analysis demonstrates.

For example, in some embodiments, the amine represents about 30% of the weight of the medium, namely 2.25 kg, or about 21.4 moles of diethanolamine. Considering a 1:1 stoichiometric ratio between the amine group and formaldehyde molecule (“Case II”), it would take over 270 hours to capture one mole of formaldehyde under tested conditions. Thus, it may be anticipated that at conditions similar to those tested, over 5,000 hours of continuous adsorption under the conditions of Case II should be possible before approaching the theoretical limits of the filter's chemical capacity. It should be noted that in most office buildings, formaldehyde levels are significantly lower, typically well under 50 ppb at normal conditions, thus, indicating an operating life of multiple years for an appropriately designed formaldehyde filter sheet 120 as described.

As seen in FIG. 2A, the indoor air formaldehyde filtering system 100 may include a system for deploying a filtration medium 102 in an indoor air setting 104 and can be made similarly to an air filtration system or air handling unit. The indoor air setting 104 may include any enclosed space.

In some embodiments, the medium 102 may comprise a granular material 110. The granular material 110 may be placed in a packed bed with a predetermined thickness and cross sectional geometry, held in place by two parallel permeable screens 116 and a rigid frame 118, that together support the granular material 110 while allowing air to flow through the medium 102. The screens 116 may be permeable for allowing air to flow through the medium 102. This packed bed may be referred to as a formaldehyde filter element 120.

The filter sheet 120 may be formed in any suitable configuration, such as a generally flat rectangular sheet with the permeable screens 116 provided to enclose the medium 102.

The dimensions of the filter sheet 120 may be any suitable dimensions. In some embodiments, the filter sheet 120 may be formed with a thickness 124 between about 1 cm to 20 cm. In some embodiments, the filter sheet 120 may be formed with a thickness 124 less than about 1 cm.

An inlet 130 and an outlet 134 may guide an airflow to flow through a conduit or a cabinet 136 where filter sheets 120 are configured to come into contact with the passing air. A fan 140 can be added to boost the flow through the filter sheet 120 and may be placed at any suitable location within the indoor air setting 104. Dampers 142 may be provided to control the airflow through the filter sheet 120. Any suitable components may be used for control of the airflow and for forcing the air to flow through the filter sheet 120, such as blowers, shutters and/or valves.

In some embodiments, the formaldehyde filtering system 100 may comprise a single filter sheet 120.

In some embodiments, the physical layout of the filter medium 102 may be very important for a scalable solution. To accommodate large air streams, rather than construct a single larger filter sheet 120, multiple filter sheets can be combined in a v-bank formation 136, as shown in FIG. 2A, or other parallel stacking configurations to enable a high air throughput system. Alternatively, one or more filter structures 120 with non-planar shapes can be formed to achieve higher surface area. An exemplary filter structure 120 is shown in FIG. 2B to be configured in a non-planar shape 144 comprising a relatively high surface area.

In some embodiments, the filter may comprise any suitable form, such as sheets, films, monoliths, linings of interiors of air ducts, and wall linings.

In some embodiments, the formaldehyde filtering system 100 can be in-line with an existing ventilation system or set aside as a by-pass or slip-stream topology, in other words a parallel conduit that bypasses the main airflow conduit, allowing part of the airflow to proceed to the bypass while the rest proceeds through the main conduit.

In some embodiments, as seen in FIG. 2C, the formaldehyde filtering system 100 may be in line with a main air stream or airflow 146 of the indoor air setting 104, whereby it may not need additional fans or dampers, thus simplifying the design of the formaldehyde filtering system 100. The main airflow may include the airflow within an air management system 148 of the indoor air setting 104, such as an HVAC system.

In some embodiments, the formaldehyde filtration can be performed in a separate filtration module, namely the filter sheets 120 may be positioned on a parallel flow path to the main air stream circulation 146, as seen in FIG. 2D. The airflow may be over and/or through the solid supported amine medium in a parallel “slip-stream” to the main air circulation path 146. An advantage of such a configuration could be that it does not introduce a flow impedance and a pressure drop for the main air circulation path, and can be used or bypassed as needed, based on actual air quality, formaldehyde concentration in the indoor air and other considerations. In this configuration, the airflow through the filter sheet 120 can be controlled by the fan 140 or by dampers 142 at the inlet 130 and outlet 134 of the filter 120.

In some embodiments, the operation of the fan 140 and the dampers 142 can be controlled by an electronic controller 154 (FIG. 2A). The controller 154 can activate the formaldehyde filtering system 100 based on air quality, for example, based on air quality measured by sensors 160. The sensors 160 may be configured in any suitable manner for detecting parameters of the airflow, for example, the sensors 160 may include electronic sensors. The sensors 160 may be used to measure the air quality and formaldehyde concentration in the indoor airflow and accordingly the controller 154 may control the operation of the formaldehyde filtering system 100 by opening suitable dampers or turning on the fan.

In some embodiments, the filter sheets 120 may be designed for easy replacement so that once the medium 102 is no longer effective, the filter sheets 120 can easily be replaced on site without requiring much effort or skill.

In some embodiments, the enclosed space may comprise any indoor space such as a building, such as an office building, a commercial building, a bank, a residential building, a house, a school, a factory, a hospital, a store, a mall, an indoor entertainment venue, a storage facility, a laboratory, a vehicle, an aircraft, a ship, a bus, a theatre, a partially and/or fully enclosed arena, an education facility, a library and/or other partially and/or fully enclosed structure and/or facility.

Various implementations of some of embodiments disclosed, in particular at least some of the processes discussed (or portions thereof), may be realized in digital electronic circuitry, integrated circuitry, specially configured ASICs (application specific integrated circuits), computer hardware, firmware, software, and/or combinations thereof. These various implementations, such as associated with the controller 154 or control unit, for example, may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Such computer programs (also known as programs, software, software applications or code) include machine instructions/code for a programmable processor, for example, and may be implemented in a high-level procedural and/or object-oriented programming language, and/or in assembly/machine language. As used herein, the term “machine-readable medium” refers to any computer program product, apparatus and/or device (e.g., non-transitory mediums including, for example, magnetic discs, optical disks, flash memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a LCD (liquid crystal display) monitor and the like) for displaying information to the user and a keyboard and/or a pointing device (e.g., a mouse or a trackball, touchscreen) by which the user may provide input to the computer. For example, this program can be stored, executed and operated by the dispensing unit, remote control, PC, laptop, smart-phone, media player or personal data assistant (“PDA”). Other kinds of devices may be used to provide for interaction with a user as well. For example, feedback provided to the user may be any form of sensory feedback (e.g., visual feedback, auditory feedback, or tactile feedback), and input from the user may be received in any form, including acoustic, speech, or tactile input. Certain embodiments of the subject matter described herein may be implemented in a computing system and/or devices that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components.

The components of the system may be interconnected by any form or medium of digital data communication (e.g., a communication network). Examples of communication networks include a local area network (“LAN”), a wide area network (“WAN”), and the Internet. The computing system according to some such embodiments described above may include clients and servers. A client and server are generally remote from each other and typically interact through a communication network. The relationship of client and server arises by virtue of computer programs running on the respective computers and having a client-server relationship to each other.

Any and all references to publications or other documents, including but not limited to, patents, patent applications, articles, webpages, books, etc., presented anywhere in the present application, are herein incorporated by reference in their entirety.

Example embodiments of the devices, systems and methods have been described herein. As may be noted elsewhere, these embodiments have been described for illustrative purposes only and are not limiting. Other embodiments are possible and are covered by the disclosure, which will be apparent from the teachings contained herein. Thus, the breadth and scope of the disclosure should not be limited by any of the above-described embodiments but should be defined only in accordance with claims supported by the present disclosure and their equivalents. Moreover, embodiments of the subject disclosure may include methods, systems and devices which may further include any and all elements/features from any other disclosed methods, systems, and devices, including any and all features corresponding to systems, methods and devices for filtering formaldehyde from indoor air. In other words, features from one and/or another disclosed embodiment may be interchangeable with features from other disclosed embodiments, which, in turn, correspond to yet other embodiments. Furthermore, one or more features/elements of disclosed embodiments may be removed and still result in patentable subject matter (and thus, resulting in yet more embodiments of the subject disclosure). Also, the lack of one or more features, structure, and/or steps for one and/or another embodiment as compared to the prior art which includes such a feature(s), structure, and/or step(s) provides yet additional patentable embodiments for the present disclosure (i.e., the claims for covering such embodiments may specifically include negative limitations).

What is claimed:

1. A method for removing formaldehyde from indoor air comprising flowing an indoor airflow over and/or through a solid supported amine filtering medium, such that, at least a portion of formaldehyde entrained in the indoor airflow is removed therefrom by the amine filtering medium.

2. The system of claim 1, wherein the filtering medium comprises a material formed from the combination of liquid amine with one or more granular solid support materials selected from the group consisting of: silica, clay, alumina, carbon, polymer, fiber, or combinations thereof.

3. The method of claim 1, wherein the amine is selected from the group consisting of: 2,4-dinitrophenylhydrazine, monoethanolamine, polyethylenimine, tetraethylenepentamine, pentaethyleneheptamine, and diethanolamine.

4. The method of claim 1, wherein the filtering medium comprises granular particles ranging in size from about 0.1 mm diameter to about 3 mm diameter.

5. The method of claim 4, wherein the granular particles of the filtering medium are arranged in one or more filter sheets so as to allow interaction between the formaldehyde in the indoor air flowing through the medium and amines in the medium.

6. The method of claim 1, wherein the face velocity of the airflow impinging the filtering medium is between about 10 cm/s to about 500 cm/s.

7. The method of claim 1, wherein the face velocity of the airflow impinging the filtering medium is between about 0.5 cm/s-10 cm/s.

8. The method of claim 1, wherein the face velocity of the airflow impinging the filtering medium is between about 0.1 cm/s to about 0.5 cm/s.

9. The method of claim 1, wherein the filtering medium is provided in a form selected from the group consisting of: sheets, films, monoliths, linings of interiors of air ducts, and wall linings.

10. The method of claim 1, wherein airflow over and/or through the filtering medium is facilitated by at least one of a fan, a blower, a valve, a shutter and a damper.

11. The method of claim 1, wherein the airflow over and/or through the filtering medium is configured in a parallel slip stream to a main air circulation path of the indoor airflow.

12. A system for removing formaldehyde from indoor air comprising:
an indoor air inlet for at least one of receiving and directing an indoor airflow to and/or from an enclosed space; and
a formaldehyde filter configured to receive the indoor airflow prior to the indoor airflow being returned to the enclosed space, the filter including a solid supported amine filtering medium configured to intercept formaldehyde upon the indoor airflow flowing over and/or through the filtering medium.

13. The system of claim 12, wherein the filtering medium comprises a material formed from the combination of liquid amine with one or more granular solid support materials selected from the group consisting of: silica, clay, alumina, carbon, polymer, fiber, or combinations thereof.

14. The system of claim 12, wherein the filter medium comprises granular particles ranging in size from about 0.1 mm in diameter to about 3 mm in diameter.

15. The system of claim 12, wherein the amine is selected from the group consisting of: 2,4-dinitrophenylhydrazine, monoethanolamine, polyethylenimine, tetraethylenepentamine, pentaethyleneheptamine, and diethanolamine.

16. The system of claim 12, further comprising one or more fans configured to provide velocity to the airflow.

17. The system of claim 16, a face velocity of the airflow impinging the filtering medium of between about 10 cm/s to about 500 cm/s.

18. The system of claim 16, wherein a face velocity of the airflow impinging the filtering medium is between about 0.5 cm/s to about 10 cm/s.

19. The system of claim 16, wherein a face velocity of the airflow impinging the filtering medium is between about 0.1 cm/s to about 0.5 cm/s.

20. The system of claim 12, further comprising a controller and air quality sensors, wherein the controller activates the system for removing formaldehyde from indoor air based on air quality measurements measured by the air quality sensors.

21. The system of claim 12, wherein the formaldehyde filter comprises one or more filter sheets containing granular particles of the filtering medium.

22. The system of claim 21, wherein the one or more filter sheets comprise a plurality of filter sheets arranged in at least one of a v-bank formation and a parallel stacking configuration.

23. The system of claim 12, wherein the filtering medium is in a form selected from the group consisting of: sheets, films, monoliths, linings of interiors of air ducts, and wall linings.

24. The system of claim 21, wherein the filter sheet comprises a thickness between about 1 cm to 20 cm.

25. The system of claim 21, wherein the filter sheet comprises a thickness less than about 1 cm.

26. The system of claim 21, wherein the filter sheet is formed as a flat rectangular sheet with permeable screens for enclosing the filtering medium.

27. The system of claim 21, wherein the filter sheet is formed in a non-planar shape.
